(19) United States
(12) Patent Application Publication
(10) Pub. No.: US 2012/0068715 A1
(43) Pub. Date: Mar. 22, 2012

(54) MODULAR ENERGY STORAGE SYSTEM FOR DRIVING ELECTRIC MOTOR

(75) Inventor: Jesper Martaeng, Lerum (SE)

(73) Assignee: Volvo Lastvagnar AB, Goteborg (SE)

(21) Appl. No.: 13/321,494

(22) PCT Filed: May 19, 2009
(86) PCT No.: PCT/SE2009/000259

§ 371 Date: Nov. 18, 2011

(51) Int. Cl. G01N 27/416

(52) U.S. Cl. 324/434

(57) ABSTRACT

A battery module is provided for a battery system including at least two battery modules, where each battery module is provided with a module monitoring unit arranged to monitor at least one performance related parameter for each secondary cell in the battery module. Parameters relating to the performance for each battery module are stored in a memory on the respective module monitoring unit. An energy storage system with a battery pack including such a battery monitoring unit for monitoring the battery pack and a modular system of battery packs, each including at least two replaceable, interchangeable battery modules is also provided. The energy storage system can further include super- or ultracapacitor modules.

### BACKGROUND AND SUMMARY

The invention relates to the technical field of energy storage systems for driving at least one stationary electric motor or at least one electric motor arranged to drive a land vehicle or a waterborne vessel.

Energy storage systems for driving at least one stationary electric motor or at least one electric motor arranged to drive a land vehicle or a waterborne vessel often comprise battery packs with a number of series connected secondary cells.

For example, individual battery modules formed of one or more secondary cells may not have the same capacity and certain deviations in capacity may occur due to manufacturing and other variances. Considering a normal distribution of capacity for the battery modules or secondary cells, the weakest cell or battery module in the battery pack may become a limiting factor in the battery pack, thereby decreasing overall efficiency. If one secondary cell or battery module breaks down the system may not be able to supply a desired power output, and may even fail altogether. When this occurs it is often necessary to replace the complete battery pack, leading to a high repair cost.

It is desirable to provide a battery module for a battery pack and an energy storage system comprising at least one such battery pack with an improved monitoring system. It is also desirable to provide a battery module for a battery pack with means for facilitating reconditioning of said battery module.

The invention relates, according to an aspect thereof, to a battery module for a battery pack and an energy storage system comprising at least one battery pack for driving one or more electric motors and/or electrically operated accessories associated with said at least one electric motor. For example, the energy storage system may be arranged to drive at least one stationary electric motor or at least one electric motor arranged to drive a land vehicle or a waterborne vessel. Such a vehicle or vessel may be propelled by electric power or use a hybrid drive arrangement comprising one or more power sources in addition to a battery pack, for example, a fuel cell arrangement or an internal combustion engine operated using a suitable gaseous or liquid fuel. The additional power sources may be used to drive the vehicle directly or to drive a generator supplying electric power to the at least one motors and/or to supplement or charge the at least one battery pack. In the case of a vehicle or vessel, the energy storage system may also supply power to drive auxiliary devices or other on-board systems.

The energy storage system may comprise at least one battery pack which comprises at least two battery modules connected in series or in parallel. A set number of battery modules may be connected in series in order to supply a predetermined voltage. Depending on the number of battery modules, multiple sets of battery modules may be connected in parallel to allow an increased power output. Each battery module may in turn comprise at least two secondary cells. The secondary cells can be connected in series, but may also be connected in parallel. As for the battery modules, a set number of secondary cells may be connected in series in order to supply a predetermined battery module voltage. Similarly, multiple sets of secondary cells may be connected in parallel to allow an increased power output from the battery module. The multiple battery modules are configured to provide power to the one or more electric motors and/or electrically operated accessories associated with said at least one electric motor. The at least one electric motor and the said accessories may be operated using the same or different voltage levels.

The number of cells per battery module, the number of battery modules per battery pack and the relative serial and/or parallel connections of the secondary cells and/or battery modules is decided by the required output power and the intended use of the battery pack. For instance, a deciding factor may be whether the battery pack is required to supply an electric motor or electrical system with a suitable voltage, e.g. 12, 32 or 64 Volt. The number of secondary cells and/or battery modules is also dependent on the type of secondary cells used. Examples of suitable types of rechargeable secondary cells are lithium cells (Li-ion), nickel-metal hydride cells (NiMH), nickel cadmium cells (NiCd) or lithium ion polymer cells (Li-ion polymer).

The battery pack also comprises a battery monitoring unit, or BMU, connected to each the plurality of battery modules. Each of the plurality of battery modules is provided with a module monitoring unit, or MMU, configured to monitor at least one performance related parameter of the battery module and/or the secondary cells in the battery module. A non-limiting list of examples of performance related parameters are State-of-Charge (SOC), State of Health (SOH), Depth of Discharge (DOD), output voltage, temperature, Internal resistance and impedance. For instance, in applications such as standby emergency power plant the SOC gives an indication of whether a battery pack will be able to support a desired load when requested. An indication of the SOH may help to anticipate problems, to make fault diagnosis or to plan replacement of component parts. For electric vehicle applications, the ability to achieve a desired range when requested is most important. Hence the SOH may be based on a comparison of the current capacity with the current capacity of a new battery. Alternatively, for hybrid electric vehicle applications the ability to deliver a specified power is most important. Hence the SOH may be based on a comparison of the present DC resistance (or 1 kHz impedance) now with the DC resistance (or 1 kHz impedance) of a new battery.

To determine a value for the SOH, the battery monitoring unit evaluates the SOH of the secondary cell, battery module or the battery pack under its management and stores it in a memory. Then, the SOH is compared to a threshold, to determine the suitability of the battery pack to a given application. This may be done by the application in which the battery pack or the battery modules are used. Knowing the SOH of a given battery pack or battery module and the SOH threshold of a given application, a determination can be made whether the present battery conditions make it suitable for that application. An estimate can then be made of the battery module or the secondary cells useful lifetime in that application

As SOH does not correspond to a particular physical quality, there is no consensus in the industry on how SOH should be determined. The designer of a battery monitoring unit may use any of the following parameters (singly or in combination) to derive an arbitrary value for the SOH.
Internal resistance/impedance/conductivity
Capacity
Voltage
Leakage (self discharge)
Ability to accept a charge
Number of charge/discharge cycles
Operating hours
Calendar time

In addition, the designer of the battery monitoring unit may define an arbitrary weight for each of the parameter's contribution to the SOH value. Any parameter which changes significantly with age, such as battery module or secondary cell impedance or conductivity, can be used as a basis for providing an indication of the SOH of the secondary cells and/or the battery module. Changes to these parameters will normally signify that other changes have occurred which may be of more importance to the user. These could be changes to the external battery pack performance such as the loss of rated capacity or increased temperature rise during operation or internal changes such as corrosion.

Because the SOH indication is relative to the condition of a new battery pack, the measurement system may store a history of the initial conditions or at least a set of standard conditions. If battery module or secondary cell impedance is the parameter being monitored, the system must store the initial impedance of a new secondary cell in a memory as a reference. If counting the charge/discharge cycles of the battery module or secondary cell is used as a measure of the battery pack usage, the expected cycle life of a new battery module or secondary cell would be used as the reference.

It may be possible estimate the SOH for the battery module or the secondary cell from a single measurement of a performance related parameter. For improved accuracy, several battery module or secondary cell parameters may be measured, all of which should vary with the age of the battery pack. An estimate of the SOH can be made from a combination of these parameters. Examples are capacity, internal resistance, self-discharge, charge acceptance, discharge capabilities and cycle counting. The absolute readings may depend on the secondary cell chemistry involved. Weighting may be added to individual parameters based on experience, the secondary cell chemistry and the importance the particular parameter in the application for which the battery pack is used. If any of these variables provide marginal readings, the end result may be affected. A battery pack, battery module or secondary cell may have a good capacity but a high internal resistance. In this case, the SOH estimation will be lowered accordingly. Similar degradation points are added if the battery module or secondary cell has high self-discharge or exhibits other chemical deficiencies. The points scored for the module or secondary cell is compared with the points assigned to a new module or secondary cell to give a percentage result for the SOH.

Measurements and data processing require a microprocessor to deliver the desired results. A microprocessor is provided on the battery monitoring unit or on the battery monitoring unit and on each of the module monitoring units. For automated measurements, the initial conditions and a history of measured and/or calculated performance related parameters can be stored in a memory on each battery module to facilitate this process. The stored history can be modified in a learning process as more data becomes available to refine the estimations. Fuzzy logic may be used to combine the stored history with the measurements to improve the accuracy of the results.

The battery monitoring unit may also include a battery balancer. A battery balancer is a device in a battery pack which can actively transfer energy into a weak secondary cell from other more healthy secondary cells in a battery module. The function may also be used for battery modules in a battery pack. The battery balancer may also include the function of a battery regulator to prevent overcharging.

A battery monitoring unit may include active balancing as well as temperature monitoring, charging, and other features to maximize the life of a battery pack. The battery pack may contain more than one battery module or multiple secondary cells connected either in series or in parallel or both. When the battery pack or the battery module is discharged and the secondary cells are discharging at different rates, the voltage of each secondary cell is different when the battery pack or the battery module is fully discharged. Subsequently, if the battery pack or the battery module is charged connecting only two wires, then all the secondary cells cannot be charged properly because all the secondary cells are in series or parallel. The battery balancer provides solution to this problem, as it charges all the secondary cells individually.

As stated above, an aspect of the invention relates to a battery module for a battery pack comprising at least two battery modules. Each battery module is provided with a module monitoring unit arranged to monitor at least one performance related parameter for each secondary cell in the battery module, and that parameters relating to the performance for each battery module are stored in a memory on the respective module monitoring unit.

The battery monitoring unit is configured to receive the at least one performance related parameter from each of the plurality of module monitoring units. The battery monitoring unit may be hard-wired to each module monitoring unit, or be connected via a bus, local area network (LAN), or similar, using electrical or optical signal transmission. However, data may also be transmitted between the units using infrared (IR), radio frequency (RF), Bluetooth, wireless local area network (WLAN) or any other suitable means of wireless signal transmission. In response to received data the battery monitoring unit may compare measured data with stored data, calculate further performance related parameters and/or calculate ageing parameters for the battery module and/or the secondary cells in a battery module. The battery monitoring unit may store received and/or calculated data in a memory.

The memory used in the battery monitoring unit and in each module monitoring unit may be a non-volatile memory on which data can be stored and which can retain saved data without an external power supply. A suitable memory for this purpose may be a flash memory, an EEPROM, or a similar non-volatile memory.

Each module monitoring unit may be provided with a processor arranged to determine the at least one performance related parameter for the battery module. In addition to current values for the at least one performance related parameter, a history of measured and/or calculated performance related parameters for the battery module may be stored in the memory on the module monitoring unit or in the memories on the module monitoring unit and the battery monitoring unit.

In addition, the processor may be arranged to determine the at least one performance related parameter for each secondary cell in the battery module. The at least one performance related parameter for each secondary cell in the battery module may be stored in the memory on the module monitoring unit or in the memories on the module monitoring unit and the battery monitoring unit. A history of measured and/or calculated performance related parameters for the secondary cells in each battery module may be stored at least in the memory on the module monitoring unit.

At least one predetermined performance related parameter, related to the current performance and ageing, may be measured and/or received by the battery monitoring unit, which may calculate at least one further parameter. The calculated parameters relating to each module may be transmitted to the respective module monitoring unit. The measured and/or calculated performance related parameters may be stored in a memory on the respective individual module monitoring unit. The memory may store values for a current performance related parameter and/or a history of measured and/or calculated performance related parameters.

Alternatively, at least one predetermined performance related parameter, related to the current performance and ageing, may be measured by the module monitoring unit. Each module monitoring unit can then calculate a further performance related parameter. The measured and/or calculated performance related parameters may be stored in a memory on the respective individual module monitoring unit. The memory may store values for a current performance related parameter and/or a history of measured and/or calculated performance related parameters. Each module monitoring unit can then transmit values for at least one current performance related parameter and/or a history of measured and/or calculated performance related parameters back to the battery monitoring unit for storage on its memory.

In both cases a comparison of initial values, a history of subsequent values and/or current values of the at least one performance related parameter may be used to determine the current condition of each battery module and/or its secondary cells. Both arrangements allow each module monitoring unit to keep track of the current condition and the history of the battery module and/or its secondary cells. In addition, the battery monitoring unit may monitor the current condition and the history of all battery modules.

The invention further relates, according to another aspect, to an energy storage system comprising at least one battery pack comprising a battery monitoring unit for monitoring a battery pack. The battery pack may comprise at least two replaceable battery modules and each battery module comprising at least two secondary cells, wherein the battery monitoring unit is arranged to monitor at least one performance related parameter for each battery module. Each battery module is arranged to be in communication with the battery monitoring unit, that each battery module may be provided with a module monitoring unit arranged to monitor the at least one performance related parameter for each secondary cell in the battery module. The at least one performance related parameter for each battery module are stored in a memory on the respective module monitoring unit.

A history of measured and/or calculated performance related parameters for all battery modules may be stored in a memory on the battery monitoring unit. In addition, a history of measured and/or calculated performance related parameters for each battery module may be stored in a memory on the respective module monitoring unit and/or in a memory on the battery monitoring unit. The at least one performance related parameter for each secondary cell in the battery module may be stored in a memory on the respective module monitoring unit and/or in a memory on the battery monitoring unit.

At least one performance related parameter may be arranged to be measured by each module monitoring unit and to be transmitted to the battery monitoring unit. The said at least one performance related parameter determined for each module monitoring unit in the battery monitoring unit is arranged to be transmitted to and stored in the respective module monitoring unit. Each module monitoring unit may be provided with a processor arranged to determine the at least one performance related parameter for the battery module. The processor may be arranged to determine the at least one performance related parameter for each secondary cell in the battery module.

The at least one performance related parameter is arranged to be measured and/or determined and stored in each module monitoring unit. The measured and/or determined performance related parameter may be transmitted to and stored in the battery monitoring unit.

In order to achieve this, each module monitoring unit may be connected to at least one sensor arranged to measure a performance related parameter for each secondary cell. For this purpose, the module monitoring unit may be provided with sensors for measuring at least the voltage and temperature. The performance related parameter may be measured for each battery module and/or for each secondary cell.

In response to received and/or calculated data the battery monitoring unit may perform independent adjustment of at least one parameter for the battery module, such as the state-of-charge of each of the plurality battery modules based on the performance related parameter. The battery monitoring unit may monitor the state of each battery module and each secondary cell in said battery module, in order to adjust the output power of one or more battery modules depending on said state. If necessary, the battery monitoring unit may partially or completely bypass one or more battery modules in order to prevent or minimize damage to the battery pack. The battery pack may then still be operated, albeit with a reduced maximum power output, or even with a reduced nominal voltage output. If one or more secondary cells show signs of ageing, overheating or some other malfunction that can not be corrected by the battery monitoring unit, the battery module may be shut down. The battery monitoring unit may then transmit a signal indicating that a replacement of one or more malfunctioning battery modules is required to an operator, an on-board diagnostics unit or to a central control unit.

Finally, the invention relates, according to another aspect, to a modular system of battery packs each comprising at least two replaceable, interchangeable battery modules. Each battery module comprises at least two secondary cells. The battery modules in the modular system may be substantially identical, comprising the same number of secondary cells and having standardized electrical connectors. Alternatively, the battery modules in the modular system may comprise or may have a number of different standardized sizes, each size of battery module comprising the same or a different number of secondary cells. Battery modules of different types and/or having different voltages may also be combined within a battery pack, such as modules comprising lithium cells, nickel-metal hydride cells or lithium ion polymer cells. The battery pack can then be assembled using such battery modules in order to provide a battery pack arranged to supply a desired voltage or a predetermined number of ampere hours for a particular application. This allows any such battery module to be removed from the battery pack and to be replaced by a new or reconditioned battery module of the same type in the same system. If required, a battery module may also be re-positioned within the battery pack. Each battery pack comprises a battery monitoring unit arranged to recognize each module monitoring unit and to monitor at least one performance related parameter for each battery module, irrespective of its type, voltage or size. Each battery module in each battery pack is provided with a module monitoring unit arranged to monitor the said at least one performance related parameter for the battery module and/or each secondary cell in the battery module. Said at least one performance related parameter for each battery module is stored in a memory on the respective module monitoring unit.

As stated above, a battery module may be removed and replaced by a new or reconditioned battery module of the same type. A battery module may also be re-positioned within the battery pack or transferred to another battery pack, for instance to replace a malfunctioning battery module. A replaced or re-positioned battery module may, upon connection to the battery pack, be arranged to transmit the at least one performance related parameter stored on the module monitoring unit to the battery monitoring unit on the said battery pack. A new or replaced battery module may have an initial value for the at least one performance related parameter stored on the module monitoring unit, which initial value can be used as a reference value when monitoring the ageing or function of the battery module.

Hence, when a battery module is connected to a battery pack and its battery monitoring unit, a data transfer relating to the at least one performance related parameter, and/or the history of stored parameters, takes place between the module monitoring unit and the battery monitoring unit. The data transfer may be requested by either of the module monitoring unit or the battery monitoring unit, either upon connection of the battery module or the next time the battery monitoring unit and the battery pack are in use. Suitable battery modules and energy storage systems for use in a modular system of battery packs have been described in detail above.

Within the scope of the modular system of battery packs outlined above, a replacement battery module that has been disconnected from battery pack is arranged to retain the at least one performance related parameter, and/or a history relating to said parameter, in a memory on the respective module monitoring unit. While located remote from a battery pack, the module monitoring unit can be triggered to transmit the at least one performance related parameter and/or the history of stored parameters to a further battery monitoring unit. This further battery monitoring unit is not necessarily associated with a battery pack, but may be part of a diagnostics tool used during reconditioning of the battery module. This allows the status of the battery module and/or the secondary cells to be determined during a battery module reconditioning operation. The transmitted data may contain information relating to the condition of the battery module, as well as the individual cells. By performing a diagnostic check of the module it is possible to determine whether the module is possible to re-use and, if so, which secondary cell or cells will need repair or replacement. After a completed reconditioning the battery module may be placed in any suitable battery pack encompassed by the modular system of battery packs.

The energy storage system may comprise a battery pack of any of the above types combined with super- or ultracapacitors. Such an energy storage system may comprise a modular battery pack of any desired type and/or size combined with super- or ultracapacitor modules. Here, a battery monitoring unit may be adapted to monitor all such modules and at least all battery modules are provided with a module monitoring unit. Of course it is also possible to have only super-/ultracapacitors in a battery pack.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 schematically illustrates a battery pack according to an aspect of the invention;

FIG. 2 shows a schematically illustrated modular system of battery packs according to an aspect of the invention.

### DETAILED DESCRIPTION

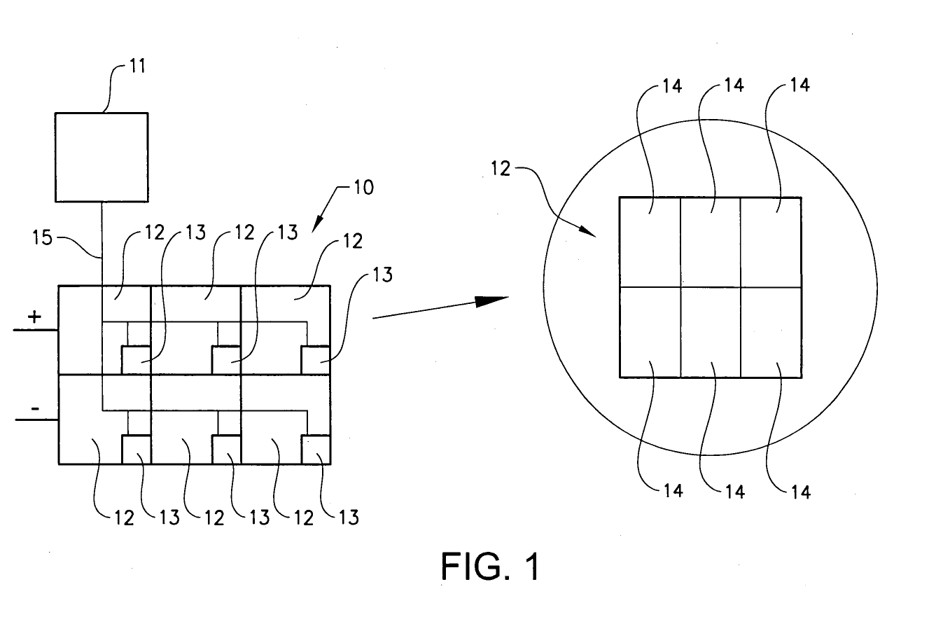

FIG. 1 describes an aspect of the invention applied to a battery pack 10 for a battery-powered vehicle, which can be an electric and hybrid electric vehicle, or any other type of vehicle. In this example, a battery monitoring unit 11 is used to monitor the operation and status of 6 battery modules 12. The battery monitoring unit 11 can be mounted adjacent to or remote from the battery pack 10.

The battery monitoring unit 11 determines the state-of-health (SOH) based on a performance related parameter, such as temperature, voltage, battery impedance, battery pack current, and battery monitoring unit equalizing current. The amount of energy stored in or delivered from each battery module 12 is monitored and, the amount of energy stored in each battery module 12 and/or delivered by each battery module 12 can be independently adjusted by the battery monitoring unit 11 to balance or equalize the amount of energy distributed between the battery modules 12.

With reference to FIG. 1, the battery pack 10 in this example comprises six battery modules 12 connected in series and arranged to provide power to a battery-powered vehicle (not shown). Each of the battery modules 12 has a SOH which is determined by the battery monitoring unit 11 connected to the battery modules 12. Each of the battery modules 12 is provided with a module monitoring unit 13 connected to the battery monitoring unit 11, which is arranged to monitor a performance related parameter which in this case is related to the SOH. The battery monitoring unit 11 is configured to receive a measured performance related parameter from each of the module monitoring units 13 and independently calculate and adjust the state-of-charge of each of the battery modules 12 based on the performance related parameter. The battery modules 12 in this example comprise six secondary cells 14, as shown for one of the battery modules.

The exact number of secondary cells in a given battery module can vary, depending on the type of secondary cell used and the application of the battery module. Similarly, the number of battery modules in the battery pack can vary depending on the same factors.

In the current example, the battery pack 10 is arranged within an electric or hybrid electric vehicle. The battery pack 10 can be connected to an external power source (not shown), such as a high voltage bus, via an inlet or a charging connector (not shown). The battery pack 10 can be connected to or disconnected from the power source with any suitable means, for example by relays. A first relay can connect the positive side of battery pack 10 to the positive side of the power source. Similarly, a second relay can connect the negative side of battery pack 10 to the negative side of the power source.

The battery monitoring unit 11 is used to control the operational functions of the battery pack 10 and independently adjust the state-of-charge of each of the battery modules 12 in order to balance and/or equalize the amount of energy distributed among the battery modules 12. Depending on the state-of-charge determined for each of the battery modules 12, the battery monitoring unit 11 will determine which battery modules 12 that will receive an equalizing current. For example, the battery monitoring unit 11 is configured to provide the equalization current to one of the battery modules 12 to adjust the state of charge of the individual battery without providing the equalization current to other battery modules 12.

At least one performance related parameter is measured using a corresponding sensor on the battery module. The battery monitoring unit 11 receives the performance related parameter from each of the module monitoring units 13. The battery monitoring unit 11 is arranged to monitor the status and condition for the individual battery modules 12 in the battery pack 10.

The battery monitoring unit can be adapted for any suitable battery technology, including lead-acid batteries, nickel-metal-hydride batteries, nickel cadmium cells (NiCd), lithium batteries (Li-ion) or lithium ion polymer cells (Li-ion polymer).

An arrangement according to an aspect of the invention can be used to manage the battery pack at the battery module level and at the secondary cell grouping level. Each secondary cell grouping, and/or battery module will have a module monitoring unit associated with it and the battery monitoring unit for the battery pack will control the charging and distribution of energy for the battery modules controlled by the battery monitoring unit.

The battery modules are often connected together in a series configuration, and while the current example uses six module monitoring units and battery modules, it should be understood that more or fewer battery modules and module monitoring units can be used depending on the application. Hence, the battery modules can be connected in a series or in a parallel configuration, and the number of battery modules can be selected dependent on the requirements of the desired application. The battery monitoring unit 11 and each of the module monitoring units 13 is provided with one or more processors and a memory storage unit for storing at least one performance related parameter and a history of performance related parameters or calculated data relating to the state-of-charge. In FIG. 1 the module monitoring units 13 are schematically indicated including processors, memory units and sensors for measuring performance related parameters. Each module monitoring unit 13 is connected to the battery monitoring unit 11 by a serial bus 15. Additionally, each of the module monitoring units preferably has an isolated converter (not shown) as an output and this output is used to control the flow of current for the charging/discharging of the battery module. Each of the module monitoring units can also have an external temperature sensor for monitoring the temperature of the associated battery module. The module monitoring units 13 can acquire data synchronously upon command from the battery monitoring unit 11 and report the status of its associated battery module 12 back to the battery monitoring unit 11. The data representing the at least one performance related parameter is used to calculate the state-of-charge, either in the battery monitoring unit 11 or in each of the module monitoring units 13. The at least one performance related parameter and a history of measured and/or calculated performance related parameters relating to the state-of-charge for each battery module 12 is stored in at least the memory storage unit on the respective module monitoring unit.

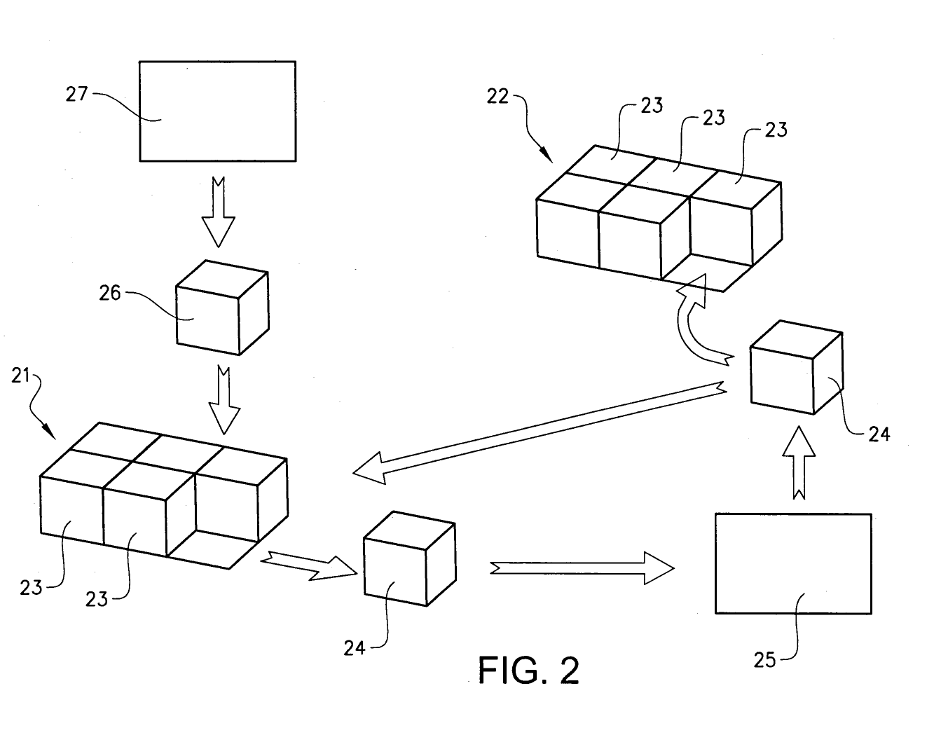

The battery pack 10 transmits the status of component parts using the serial bus 15. In addition, even if the battery pack is in a standby/disconnected state, energy can be shared between battery modules 12 within the battery pack via isolated connectors (not shown) connecting each battery module. This energy, sharing function allows the battery pack to balance the battery modules 12 within the battery pack 10. The energy sharing can occur during various vehicle operational modes, including vehicle propulsion and battery re-charging cycles. It should be noted that the battery pack 10 of the present invention is not needed to be dependent on voltage only for determining and effectuating energy equalization. While voltage can be one performance related parameter, other measured or calculated performance related parameters such as temperature, state-of-charge, etc. can also be considered in accordance with the present invention, individually or in one or more combinations. The one or more parameters can be loaded into battery monitoring unit 11 and then transferred to each of the module monitoring units 13. The one or more parameters can be selected in order to perform a specific balancing and equalization operation desired for a given application. FIG. 2 shows a schematically illustrated modular system of battery packs. The figure shows a first and a second battery pack 21, 22 each comprising six replaceable, interchangeable battery modules 23. Each battery module 23 comprises at least two secondary cells (not shown). The battery modules 23 in the modular system are substantially identical, comprising the same number of secondary cells and having standardized electrical connectors. This allows any such battery module 23 to be removed from any battery pack and to be replaced by a new or reconditioned battery module in the same system. If required, a battery module may also be re-positioned within the battery pack. Each battery pack 21, 22 comprises a battery monitoring unit (not shown) arranged to monitor at least one performance related parameter for each battery module 23. Each battery module 23 in each battery pack 21, 22 is provided with a module monitoring unit (not shown) arranged to monitor the said at least one performance related parameter for the battery module 23 and/or each secondary cell in the battery module 23. Said at least one performance related parameter for each battery module 23 is stored in a memory on the respective module monitoring unit.

The battery monitoring unit is arranged to monitor the state of the battery modules 23 and to indicate if a battery module 24 develops a malfunction. As indicated in FIG. 2, a malfunctioning battery module 24 can be removed from the first battery pack 21 and be relocated to a reconditioning facility 25. The disconnected battery module is arranged to retain the at least one performance related parameter, and/or a history relating to said parameter, in the memory on the module monitoring unit. During reconditioning, the module monitoring unit is triggered to transmit the at least one performance related parameter and/or the history of stored parameters to a further battery monitoring unit. This further battery monitoring unit is located in the reconditioning facility and is part of a diagnostics tool used during reconditioning of the battery module. This allows the status of the battery module and/or the secondary cells to be determined during a battery module reconditioning operation. The transmitted data contains information relating to the condition of the battery module, as well as the individual cells. By performing a diagnostic check of the module it is possible to determine whether the module is possible to re-use and, if so, which secondary cell or cells will need repair or replacement.

The first battery pack 21 can have the missing battery module replaced by a new battery module 26 of the same type from a supply facility 27 for spare component parts. In this case, the reconditioned battery module 24 can be re-used in the second battery pack 22, when a battery module is replaced. Alternatively, the original battery module 24 can be returned to the first battery pack 21 after being reconditioned. A replaced battery module 24, 26 will, upon connection to the battery pack, be arranged to transmit an initial value for the at least one performance related parameter stored in the memory on its module monitoring unit to the battery monitoring unit on the said battery pack 21, 22. Hence, when a battery module is connected to a battery pack and its battery monitoring unit, a data transfer relating to the at least one performance related parameter, and/or the history of stored parameters, takes place between the module monitoring unit and the battery monitoring unit. The data transfer may be requested by either of the module monitoring unit or the battery monitoring unit, either upon connection of the battery module or the next time the battery monitoring unit and the battery pack are in use. Suitable battery modules and energy storage systems for use in a modular system of battery packs have been described in detail above.

The invention is not limited to the embodiments described above but may be varied within the scope of the appended claims.

1. Battery module for a battery system comprising at least two battery modules, characterized in that each battery module is provided with a module monitoring unit (13) arranged to monitor at least one performance related parameter for each secondary cell (14) in the battery module, and that parameters relating to the performance for each battery module are stored in a memory on the respective module monitoring unit (13)

2. Battery module according to claim 1, characterized in that the battery module monitoring unit (13) is provided with a processor arranged to determine the at least one performance related parameter for the battery module.

3. Battery module according to claim 2, characterized in that a history of the at least one performance related parameter for the battery module is stored in the memory on the module monitoring unit (13).

4. Battery module according to claim 2, characterized in that the processor is arranged to determine the at least one performance related parameter for each secondary cell (14) in the battery module.

5. Battery module according to claim 4, characterized in that the at least one performance related parameter for each secondary cell (14) in the battery module is stored in the memory on the module monitoring unit (13).

6. Energy storage system with a battery pack comprising a battery monitoring unit (11) for monitoring the battery pack, said battery pack comprising at least two replaceable battery modules (12) and each battery module (12) comprising at least two secondary cells (14), wherein the battery monitoring unit (11) is arranged to monitor at least one performance related parameter for each battery module, characterized in that each battery module (12) is arranged to be in communication with the battery monitoring unit (11), that each battery module (12) is provided with a module monitoring unit (13) arranged to monitor the at least one performance related parameter for each secondary cell (14) in the battery module, and that the at least one performance related parameter for each battery module are stored in a memory on the respective module monitoring unit (13).

7. Energy storage system according to claim 6, characterized in that a history of the at least one performance related parameter for all battery modules (12) is stored in a memory on the battery monitoring unit (11).

8. Energy storage system according to claim 6 or 7, characterized in that a history of the at least one performance related parameter for each battery module (12) is stored in a memory on the respective module monitoring unit (13).

9. Energy storage system according to any one of claims 6-8, characterized in that the at least one performance related parameter for each secondary cell (14) in the battery module (12) is stored in a memory on the respective module monitoring unit (13).

10. Energy storage system according to any one of claims 6-9, characterized in that at least one performance related parameter is arranged to be measured by each module monitoring unit (13) and is transmitted to the battery monitoring unit (11), and that said at least one performance related parameter determined for each module monitoring unit (13) in the battery monitoring unit (11) is arranged to be transmitted to and stored in the respective module monitoring unit (13).

11. Energy storage system according to any one of claims 6-9, characterized in that each module monitoring unit (13) is provided with a processor arranged to determine the at least one performance related parameter for the battery module.

12. Energy storage system according to claim 11, characterized in that the processor is arranged to determine the at least one performance related parameter for each secondary cell (14) in the battery module.

13. Energy storage system according to claims 11 or 12, characterized in that at least one performance related parameter is arranged to be measured and/or determined and stored in each module monitoring unit (13), and to be transmitted to and stored in the battery monitoring unit (11).

14. Energy storage system according to any one of claims 6-13, characterized in that each module monitoring unit (13) is connected to at least one sensor arranged to measure a performance related parameter for each secondary cell.

15. Energy storage system according to claim 14, characterized in that the module monitoring unit (13) is provided with sensors for measuring at least the voltage and temperature for each secondary cell.

16. Energy storage system according to any one of claims 6-15, characterized in that said energy storage system further comprising super- or ultracapacitor modules.

17. Energy storage system according to claim 16, characterized in that said battery monitoring unit is adapted to monitor both said super- or ultracapacitor modules and said battery modules.

18. Modular system of battery packs, each comprising at least two replaceable, interchangeable battery modules (12), each battery module (12) comprising at least two secondary cells (14), wherein each battery pack comprises a battery monitoring unit (11) arranged to monitor at least one performance related parameter for each battery module, characterized in that each battery module (12) in each battery pack is provided with a module monitoring unit (13) arranged to monitor the said at least one performance related parameter for the battery module (12) and/or each secondary cell (14) in the battery module, and that said performance related parameter for each battery module (12) is stored in a memory on the respective module monitoring unit (13), and that a replacement battery module, when connected to the battery pack, is arranged to transmit the at least one performance related parameter to the battery monitoring unit (11).

19. Modular system of battery packs according to claim 18, characterized in that a replacement battery module (12) disconnected from battery pack is arranged to transmit at least one performance related parameter to a further battery monitoring unit (11), in order to determine the status of the battery module (12) and the secondary cells (14) during a battery module (12) reconditioning operation.
